(19) United States
(12) Patent Application Publication
(10) Pub. No.: US 2012/0144441 A1
(43) Pub. Date: Jun. 7, 2012

(54) METHOD FOR DIAGNOSING 3D STATE INFORMATION, AND BROADCAST RECEIVER

(76) Inventors: Chang Sik Yun, Seoul (KR); Jong Yeul Suh, Seoul (KR)

(21) Appl. No.: 13/389,964

(22) PCT Filed: Aug. 12, 2010
(86) PCT No.: PCT/KR10/05312

§ 371 Date: Feb. 10, 2012

Related U.S. Application Data
(60) Provisional application No. 61/233,483, filed on Aug. 12, 2009.

(51) Int. Cl. H04N 21/442

(52) U.S. Cl. 725/107

(57) ABSTRACT

The present invention relates to a method for diagnosing 3D state information, and a broadcast receiver. One embodiment of a cable broadcast receiver according to the invention comprises: a cable set-top box that receives a request for 3D state information diagnosis from a communication device and requests 3D state information collection from a digital broadcast receiver according to the request; and the digital broadcast receiver that collects 3D state information and transfers the collected 3D state information to the cable set-top box according to the request from the cable set-top box, wherein the cable set-top box transfers the 3D state information collected and transferred by the digital broadcast receiver to a cable headend through the communication device and receives a 3D broadcast service based on the 3D state information transmitted from the cable headend.

### BACKGROUND OF THE INVENTION

1. Field of the Invention

The present invention relates to a method for diagnosing 3D status information and a broadcast receiver, and more particularly to a method for processing a 3D broadcasting service by defining a diagnostic protocol for diagnosing 3D status information in each broadcast receiver.

2. Discussion of the Related Art

A cable broadcast system is divided into a transmitter and a receiver. The transmitter may be a cable broadcast station that transmits a cable broadcast signal, and the receiver may be a cable broadcast receiver that receives the transmitted cable broadcast signal.

The cable broadcast station may be referred to as a system operator (SO) headend or a multiple system operator headend (MSO). In this case, the SO indicates a local cable TV broadcast provider, and several SOs may be referred to as multiple system operators (MSO).

The cable broadcast receiver is an open cable system where a point of deployment (POD) module is detached from a main body, wherein the POD module includes a conditional access (CA) system. The POD module is detachably provided in the cable broadcast receiver, and for example, a personal computer memory card international association (PCMCIA) standard card may be used for the POD module. In this case, the POD module may be referred to as a CableCARD.

In the mean time, cable headend may provide 3D video data to the cable broadcast receiver through a 3D channel, which is recently issued. However, since the standard for transmission and reception of 3D video data is not provided for the cable broadcast standard as well as 3D video data, a problem occurs in that each cable broadcast receiver fails to properly process 3D video data even though the 3D video data are actually provided from the cable headend through the 3D channel.

Moreover, in case of a cable broadcast receiver that does not a unit for processing 3D video data, loss may occur in a transmitter in view of bandwidth, and system efficiency deterioration and error operation may occur in a receiver due to 3D channel access which cannot be processed by the receiver.

Also, under such a broadcast environment, the cable headend has no information related to 3D channel processing of each cable broadcast receiver connected to a 3D channel provided by itself. For this reason, problems occur in that economic loss may occur due to billing, etc. and an upgraded premium service cannot be provided to a user.

### SUMMARY OF THE INVENTION

Accordingly, the present invention is directed to a broadcast receiver, and a method for diagnosing 3D status information that substantially obviate one or more problems due to limitations and disadvantages of the related art.

An object of the present invention devised to solve the conventional problem is to define 3D status information of each cable broadcast receiver as one of diagnostic protocols and allow the 3D status information to share a transmitting side, whereby the transmitting side may reduce bandwidth loss, provide a differentiated service to each cable broadcast receiver, and reduce economical loss such as billing, and the corresponding cable broadcast receiver may prevent system efficiency from being deteriorated and also prevent error operation from occurring.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, according to an embodiment of the present invention, a cable broadcast receiver comprises a cable set-top box configured to receive a request for 3-dimensional (3D) status information from a communication device, and transmit a request for collection the 3D status information to a digital broadcast receiver; and the digital broadcast receiver configured to collect the 3D status information according to the request of the cable set-top box and transmit the collected 3D status information to the cable set-top box, wherein the cable set-top box is further configured to transmit the 3D status information to a cable headend through the communication device and being provided a 3D broadcasting service from the cable headend based on the transmitted 3D status information.

Another example of a cable broadcast receiver comprises a cable set-top box configured to receive a request for 3D status information from a communication device, receive the 3D status information of a digital broadcast receiver connected to a specific interface according to the request to a cable headend through the communication device, wherein the cable set-top box is further configured to receive a 3D broadcasting service in accordance with the transmitted 3D status information from the cable headend processing part and transmit the 3D broadcasting service to the digital broadcast receiver.

One embodiment of a method for processing a 3-dimensional (3D) broadcasting service in a cable broadcast receiver comprises receiving, at a cable set-top box, a request for 3D status information from a communication device; requesting a request for collecting 3D status information to a digital broadcast receiver; collecting the 3D status information according to the request of the cable set-top box; transmitting the collected 3D status information to a cable set-top box; transmitting the 3D status information of the digital broadcast receiver from the cable set-top box to a cable headend through the communication device; and being provided a 3D broadcasting service from the cable headend based on the 3D status information receiving, at a cable set-top box, a request for 3D status information from a communication device; requesting a request for collecting 3D status information to a digital broadcast receiver; collecting the 3D status information according to the request of the cable set-top box; transmitting the collected 3D status information to a cable set-top box; transmitting the 3D status information of the digital broadcast receiver from the cable set-top box to a cable headend through the communication device; and being provided a 3D broadcasting service from the cable headend based on the 3D status information.

Another example of a method for processing a 3-dimensional (3D) broadcasting service in a cable broadcast receiver comprises receiving a request for 3D status information from a communication device; receiving the 3D status of a digital broadcast receiver connected to a specific interface according to the request; transmitting the 3D status information of the digital broadcast receiver to a cable headend through the communication device; and receiving a 3D broadcasting service in accordance with the transmitted diagnostic information on 3D status from the cable headend.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a conceptional diagram illustrating an example of a cable broadcast network;

FIG. 2 is a schematic block diagram illustrating an example of a cable broadcast receiver according to the present invention;

FIG. 3 is a block diagram illustrating an example of a detailed configuration of a digital broadcast receiver in a cable broadcast receiver of FIG. 2;

FIG. 4 is a diagram illustrating an example of a diagnostic protocol related to 3D status information diagnosis in a cable broadcast receiver in accordance with the present invention;

FIG. 5 is a diagram illustrating an example of diagnostic ID for 3D status information in a method for transmitting diagnostic information of a cable broadcast receiver according to the present invention;

FIG. 6 is a diagram illustrating an example of signal syntax based on a diagnostic response protocol when a single-stream is received (S-mode) in a method for transmitting diagnostic information according to the present invention;

FIG. 7 is a diagram illustrating an example of signal syntax based on a diagnostic response protocol when a cable broadcast receiver according to the present invention receives and multiplexes a plurality of broadcast streams (M-mode);

FIG. 8 is a diagram illustrating an example of 3D_status_report( ) object syntax according to the present invention; and

FIG. 9 is a flow chart illustrating a method for diagnosing and transmitting 3D status information and providing a 3D broadcasting service according to the present invention.

### DETAILED DESCRIPTION OF THE INVENTION

Other objects, features and advantages of the present invention will be apparent through the detailed description of the embodiments with reference to the accompanying drawings. Also, although the terms used in the present invention are selected from generally known and used terms considering their functions in the present invention, the terms may be modified depending on intention of a person skilled in the art, practices, or the advent of new technology. However, in special case, the terms mentioned in the description of the present invention may be selected by the applicant at his or her discretion, the detailed meanings of which are described in relevant parts of the description herein. Accordingly, the terms used herein should be understood not simply by the actual terms used but by the meaning lying within and the description disclosed herein.

The embodiments of the present invention will now be described in detail with reference to the accompanying drawings and the disclosure illustrated in the accompanying drawings. However, it is to be understood that the present invention is not limited to or restricted by the following embodiments.

Hereinafter, a method for diagnosing 3-Dimensional (hereinafter, referred to as ‘3D’) status information and a broadcast receiver according to the present invention will be described with reference to the accompanying drawings. An open cable application platform (OCAP) will exemplarily be described as a data broadcast platform according to the present invention.

In this specification, “3D status information or diagnostic information on 3D status” may be used to include various kinds of information required related to processing of 3D broadcasting service in a cable broadcast receiver, i.e., information as to whether the corresponding cable broadcast receiver supports a 3D channel, information as to what a supported 3D display type is, and information as to what a 3D profile type is. At this time, in respect of billing at a transmitting side or differentiated service to each cable broadcast receiver, 3D status information may further include additional information on other necessary 3D broadcasting service, for example, 3D channel which is being viewed by a user, a viewing timing (including accumulated time) of a corresponding 3D channel, and information on a preferred channel or preferred content when a plurality of 3D channels or 3D contents are provided. In other words, the 3D status information according to the present invention means status information in a cable broadcast receiver, on all kinds of information related to a 3D broadcasting service as well as information specified in the following embodiment.

In this specification, the 3D status information is intended to be usefully used in a cable broadcast system by being defined as one of diagnostic information in accordance with the present invention.

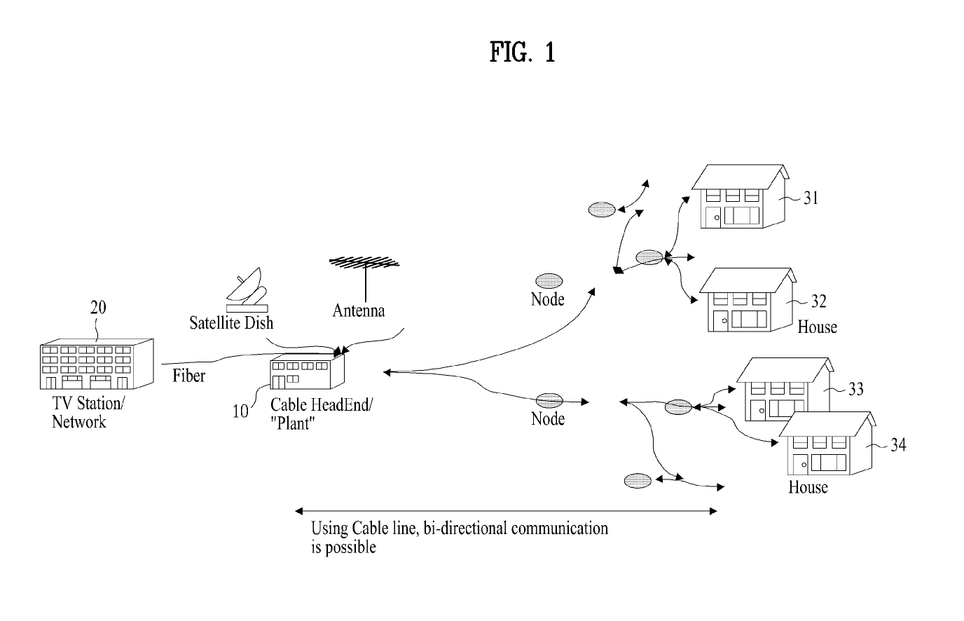

FIG. 1 is a conceptional diagram illustrating an example of a cable broadcast network in accordance with the present invention.

Referring to FIG. 1, the cable broadcast network is divided into a transmitting side and a receiving side. The transmitting side includes a broadcast station and a cable headend or plant receiving a broadcast signal from the broadcast station through various communication networks. Also, the receiving side includes a cable broadcast receiver receiving a signal transmitted from the cable headend through a network that includes a node. In this case, the cable broadcast receiver may be implemented in various formats. Examples of the cable broadcast receiver include a cable set-top box (STB) and a digital broadcast receiver coupled to the cable STB, wherein a cablecard is inserted into the cable STB. At this time, the digital broadcast receiver may be a 3DTV, which includes a unit that can process 3D video data as described later. Or, the cable STB may include components for processing the 3D video data. Also, the digital broadcast receiver is referred as a display device and the cable STB is referred as a processing part.

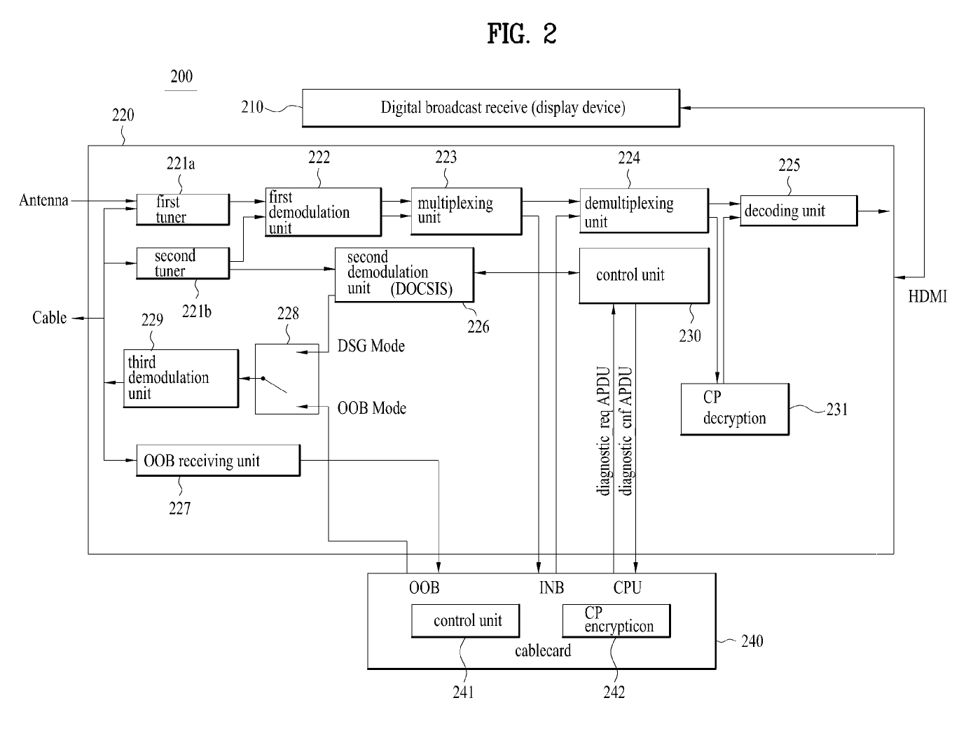

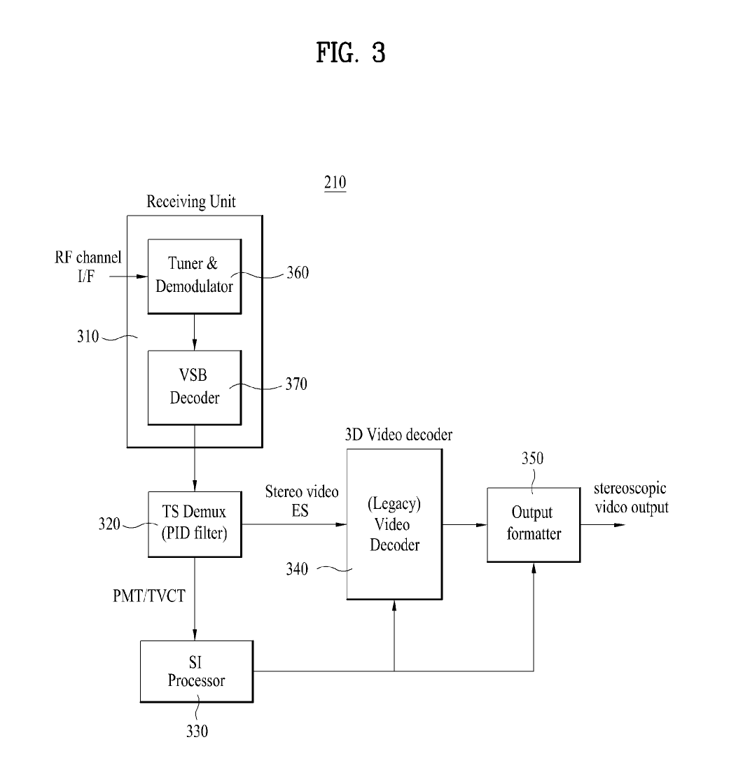

FIG. 2 is a schematic block diagram illustrating an example of a cable broadcast receiver according to the present invention, and FIG. 3 is a block diagram illustrating an example of a detailed configuration of a digital broadcast receiver in the cable broadcast receiver of FIG. 2.

Hereinafter, a schematic block of the cable broadcast receiver will be described in more detail with reference to FIG. 2 and FIG. 3.

One example of the cable broadcast receiver according to the present invention includes a cable STB receiving a request for 3D status information diagnosis from a communication device, requesting 3D status information collection to the digital broadcast receiver in accordance with the request, and a digital broadcast receiver collecting the 3D status information in accordance with the request of the cable STB and transmitting the collected 3D status information to the cable STB. The cable STB transmits the 3D status information collected by and transmitted from the digital broadcast receiver to the cable headend through the communication device, and may receive a 3D broadcasting service on the basis of the 3D status information transmitted from the cable headend.

Another example of the cable broadcast receiver according to the present invention includes a cable STB requested 3D status information diagnosis from a communication device, receiving 3D status information of a digital broadcast receiver connected to a specific interface and transmitting the 3D status information to the cable headend through the communication device in accordance with the request. The cable STB may receive a 3D broadcasting service on the basis of the 3D status information transmitted from the cable headend and provide the 3D broadcasting service to the digital broadcast receiver.

The communication device means a CableCARD, for example.

Referring to FIG. 2, a cable broadcast receiver 200 includes a digital broadcast receiver 210 and a cable STB 220. In this case, the digital broadcast receiver 210 may be a 3D broadcast receiver that includes a unit for processing a 3D broadcasting service as shown in FIG. 3, and a cablecard 240 may detachably be provided in the cable STB 220.

Referring to FIG. 2 and FIG. 3, the digital broadcast receiver 210 and the cable STB 220 may be connected with each other by using various interfaces such as a high definition multimedia interface (for example, HDMI 1.4) to properly process 3D video data through a 3D channel under a cable broadcast environment, thereby transmitting and receiving various kinds of data to and from each other. In this case, an example of the data includes the 3D status information according to the present invention. Also, in the present invention, processing of the digital broadcast receiver of the 3D video data received through the cable STB 220 follows the specification of the HDMI if necessary.

Also, the cable STB 220 and the cablecard 240 may transmit and receive information on the digital broadcast receiver 210 connected through an interface, to and from each other in accordance with various protocols.

The digital broadcast receiver 210, the cable STB 220, and the cablecard 240 may transmit and receive data to and from a cable headend of the transmitting side through a network that enables bi-directional communication directly or indirectly, and may perform operations based on the data. Also, the digital broadcast receiver 210 may be connected to peripheral devices such as mobile device, DVD player and digital cam through various types of interfaces. Also, the cablecard 240 may detachably be provided in the cable STB 220.

The cable broadcast receiver 200 according to the present invention may receive and process a 3D broadcasting service provided from/through the cable headend through the 3D channel as well as a downloadable application provided from/through the cable headend. The downloadable application may be transmitted and received between the cable headend and the cable broadcast receiver through a cable network infra having a function that can transmit data bi-directionally as shown in FIG. 1. An example of this downloadable application may include a monitor application, which is an execution management application, OCAP-Java (OCAP-J) application such as electronic program guide (EPG) or data.

First of all, the digital broadcast receiver 210 and/or cable STB 220 that can process the 3D broadcasting service will be described with reference to FIG. 3.

The digital broadcast receiver 210 of FIG. 3 includes a receiving unit 310 receiving a broadcast signal, a TS demultiplexer (Demux) 320 extracting and outputting data streams such as system information (or service information) (SI) and video data from the broadcast signal, a SI processor 330 parsing system information, a 3D video decoder 340 decoding 3D video data, and an output formatter 350 formatting and outputting the decoded 3D video data. In accordance with the embodiment, the receiving unit 310 may further include a tuner/demodulator 360 and a VSB decoder 370. The operation of each unit of the broadcast receiver will be described later with reference to the drawings.

The digital broadcast receiver 210 of FIG. 3 may process the received 3D video data as follows.

The digital broadcast receiver 210 receives a broadcast signal, which includes 3D video data and SI, from the receiving unit 310 or the cable STB 220. The digital broadcast receiver 210 parses the SI included in the broadcast signal by using the SI processor 330 to acquire 3D broadcasting service information. The 3D broadcasting service information includes information required for the decoder 340 and the output formatter 350 of the broadcast receiver to process the 3D video data. For example, the 3D broadcasting service information may include a multiplexing format (or type) of the 3D video data, position and scan direction of left and right images based on the multiplexing format, and sampling information based on the multiplexing format.

The digital broadcast receiver 210 decodes the 3D video data by using the 3D video decoder 340. At this time, the digital broadcast receiver 210 may perform a decoding operation on the basis of the acquired 3D broadcasting service information.

The digital broadcast receiver 210 formats the decoded 3D video data to be suitable for an output format by using the output formatter 350 and then outputs the formatted 3D video data. Formatting of the 3D video data includes processing of the received 3D video data in an output format considering output frequency of a display device on the basis of the 3D broadcasting service information. Also, if a multiplexing format of the received 3D video data is not matched with a multiplexing format supported by the display device or if output formats of the video data are different from each other (2D output or 3D output), the digital broadcast receiver 210 may perform required video processing.

The formatting operation of the 3D video data of the digital broadcast receiver 210 will be described in more detail. First of all, 3D broadcasting service information is acquired from the cable STB 220. In this case, the 3D broadcasting service information may be received from the cable headend through Out Of Band (OOB) as OOB_SI information and then may be provided to the digital broadcast receiver 210. The OOB_SI information may include a specific field of long-form virtual channel table (VCT) or short-form VCT section or a descriptor, for example.

Accordingly, the digital broadcast receiver 210 may determine from the system information whether a 3D broadcasting service is provided from a corresponding virtual channel. Also, the 3D broadcasting service information may include stereoscopic image configuration information on the 3D video data and information related to left/right arrangement, left/right first output, left/right inverse scan, resizing, reshaping and format conversion. The digital broadcast receiver may decode and format the received 3D video data on the basis of the aforementioned information.

Also, the digital broadcast receiver 210 may reconfigure 3D video data, which include one frame having left and right images, as a frame that includes only one of left and right images by using 3D image information, thereby outputting 2D image.

Although not shown, the output formatter 350 of the digital broadcast receiver 210 according to the present invention may include a scaler, a reshaper, a memory, and a formatter. In this case, the scaler performs resizing and interpolating of the received image. For example, the scaler may perform resizing (for example, ½ resizing, doubling ( 2/1 resizing) and quincunx inverse sampling in accordance with a format of the received image and a format of the output image, wherein the resizing may be performed at various rates in accordance with resolution and image size. The reshaper stores left and right images in a memory by extracting the left and right images from the received image and extracts the image read out from the memory. Also, if a map of the image stored in the memory is different from that of an output image, the reshaper may read out the image stored in the memory to map the read image into the output image. The memory stores or buffers the received image and then outputs the image. The formatter converts a format of an image in accordance with an image format to be displayed. For example, the formatter may convert an image of a top-bottom format into an interlaced format.

In addition, although not shown, the digital broadcast receiver 210 of FIG. 3 may further include a necessary unit in respect of processing of other broadcast signals.

The cable STB 220 will now be described with reference to FIG. 2.

The cable STB 220 according to the present invention may be provided with a detachable cable card 240.

Generally, the digital broadcast receiver 210 receives a terrestrial broadcast signal. Accordingly, according to the present invention, the cable STB 220 serves to receive a cable broadcast signal so that the digital broadcast receiver 210 may provide a cable broadcasting service, and serves to transmit the cable broadcast signal as data of a type that can be processed by the digital broadcast receiver 210. In this case, the digital broadcast receiver 210 serves as a display device only as the case may be, and may directly receive and process the cable broadcast signal from the cable STB 220. In the embodiment of FIG. 2, the cable STB 220 may receive any one or more broadcast signal of a terrestrial broadcast signal and a satellite broadcast signal as well as the cable broadcast signal.

In the mean time, examples of bidirectional communication modes between the cable broadcast receiver and the broadcast station include an OOB mode and a DOCSIS Set-top Gateway (DSG) mode for uplink service within an open cable. Accordingly, a viewer may select and view a desired program through the cable STB 220 by using any one of the above two modes. Alternatively, the viewer may directly take part in a broadcast program or select and view required information. Also, a data broadcasting service may be provided through the OOB mode and the DSG mode.

The OOB mode is prescribed by transmission standard requirements between intersec equipments within the cable STB and the cable broadcast station (or headend). On the other hand, the DSG mode means a transmission mode a cable modem control system of the cable broadcast station and a DOCSIS based cable modem within the cable STB. At this time, the DOCSIS may transmit data by using the cable modem.

FIG. 2 illustrates a cable broadcast receiver to which a hybrid mode of the OOB mode and the DSG mode is applied. In the embodiment of FIG. 2, the cable STB 220 may include a first tuner 221a, a second tuner 221b, a first demodulation unit 222, a multiplexing unit 223, a demultiplexing unit 224, a decoding unit 224, a second demodulation unit (DOCSIS) 226, an OOB receiving unit 227, a switching unit 228, a third demodulation unit 229, and a control unit 230. The cable STB 220 may further include a memory (not shown) that may store diagnostic information such as 3D status information according to the present invention in non-real time.

The first tuner 221a may tune a specific channel frequency only of terrestrial audio/video (A/V) broadcasting transmitted through an antenna and cable A/V broadcasting transmitted in an in-band mode through a cable and output the tuned specific channel frequency to the first demodulation unit 222.

The terrestrial broadcasting and the cable broadcasting are different from each other in view of their transmission modes. The first demodulation unit 222 may perform different demodulation processes for signals of different demodulation modes. If the terrestrial A/V broadcasting is modulated by a vestigial sideband modulation (VSB) mode and then transmitted and the cable A/V broadcasting is modulated by a quadrature amplitude modulation (QAM) mode and then transmitted, the first demodulation unit 222 may perform signal demodulation of the VSB mode or the QAM mode in accordance with the signal selected by the first tuner 221a.

The signals demodulated by the first demodulation unit 222 may be multiplexed with each other by the multiplexing unit 223, whereby the cable broadcasting may be output to the cablecard 240 and the terrestrial broadcasting may be output to the demultiplexing unit 224.

The embodiment of FIG. 2 considers that the cablecard 240 may process multi-streams. Accordingly, the cablecard 240 may allow the user to view broadcasting input by multiplexing two or more streams, through the cable STB 220.

The demultiplexing unit 224 receives the multiplexed broadcast signal and demultiplexes the received broadcast signal into multiple streams.

The decoding unit 225 receives and decodes the broadcast signal demultiplexed by the demultiplexing unit 224. In this way, if the broadcast signal is decoded, it is output as video/audio signal that may be viewed by the user.

The second tuner 221b tunes a specific channel frequency of data broadcasting transmitted through a cable in accordance with the DSG mode and then outputs the tuned specific channel frequency to the second demodulation unit 226. The second demodulation unit 226 may demodulate the data broadcasting of the DSG mode and then output the demodulated broadcast signal to the control unit 230.

The OOB receiving unit 227 tunes a specific channel frequency of downlink data broadcasting transmitted through a cable in accordance with the OOB mode and then outputs the tuned specific channel frequency to the cablecard 240.

In case that bi-directional communication between the cable broadcast station and the cable broadcast receiver is possible, uplink information (for example, pay per view program application, diagnostic information of the cable broadcast receiver, etc.) may be transmitted from the cable broadcast receiver to the cable broadcast station in accordance with the OOB mode or the DSG mode. Accordingly, one embodiment of the cable broadcast receiver according to the present invention may be provided with the switching unit 228 to transmit information by selecting one of the above modes.

In the OOB mode, user information or system diagnostic information is output to a third demodulation unit through the cablecard 240 and the switching unit 228, and the third demodulation unit modulates the output signal through a Quadrature Phase Shift Keying (QPSK) modulation mode and transmits the modulated signal to the cable broadcast station through the cable. If broadcast information of the user is transmitted by the DSG mode, the information may be output to a modulation unit through the control unit 230 and the switching unit 228. After the information is subjected to signal modulation by the modulation unit through QAM-16 modulation, the modulated signal may be transmitted to the cable broadcast station through the cable.

In the embodiment of FIG. 2, the cablecard 240 may receive a broadcast signal of multi-streams from the multiplexing unit 223 if the received broadcasting is the terrestrial broadcasting. Also, if the broadcast signal is scrambled, the cablecard 240 may descramble the scrambled broadcast signal, whereby the cable broadcasting may be viewed by the viewer normally.

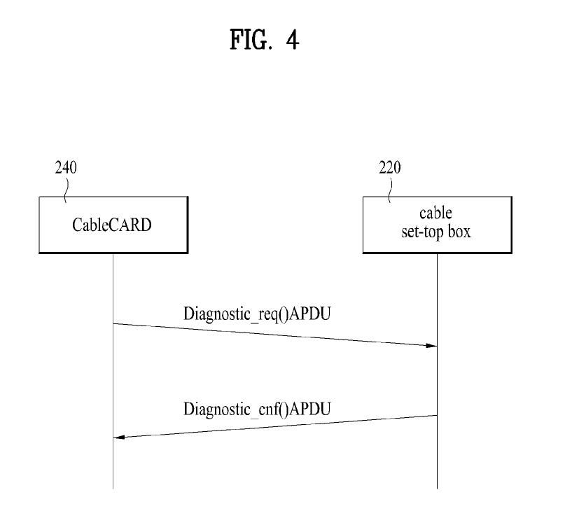

The cablecard 240 may request the control unit 230 of the cable STB 220 of 3D status information in accordance with a diagnostic protocol. In FIG. 2 and FIG. 4, an example of a diagnostic request protocol is shown as ‘diagnostic_req APDU (Application Protocol Data Unit)’, and an example of a status diagnostic response protocol is shown as ‘diagnostic_cnf APDU’.

The cable STB 220 transmits the 3D status information to the cablecard 240 through the above process, and transmits the transmitted 3D status information to the cable headend through the cable network. As a result, the cable headend may exactly check the 3D status information of each cable broadcast receiver, and may provide a differentiated service.

Hereinafter, defining diagnostic information (3D status information) in the cable broadcast system in respect of 3D broadcasting service in accordance with the present invention and processing of 3D broadcasting service in the cable broadcast receiver in accordance with the diagnostic information will be described.

The 3D status information diagnostic protocol of the cable broadcast receiver according to the present invention will be described in more detail. In this case, various diagnostic protocols such as a generic diagnostic protocol, a host device diagnostic protocol, and a simple network management protocol (SNMP) may be used as the diagnostic protocol. Hereinafter, in this specification, the generic diagnostic protocol will be described exemplarily for assistance of understanding of the present invention and convenience of description.

FIG. 4 is a diagram illustrating an example of a diagnostic protocol related to 3D information diagnosis in a cable broadcast receiver in accordance with the present invention.

As described above, FIG. 4 is for the generic diagnostic protocol. However, the generic diagnostic protocol, as shown, relates to a protocol between the cable STB constituting the cable broadcast receiver and the cablecard coupled to the cable STB. To this end, the cable STB may transmit and receive 3D status information to and from the digital broadcast receiver connected with the cable STB through the HDMI in real-time or non-real time.

As described above, if the cablecard 240 receives a diagnostic command for the 3D status information of the cable broadcast receiver 200 from the cable headend or the user, it transfers the diagnostic command to the cable STB 220 in accordance with a given rule, i.e., request/response protocol as shown in FIG. 4. If the diagnostic command is received from the cablecard 240, the cable STB 220 determines what the diagnostic command is. As a result, the cable STB 220 collects diagnostic information corresponding to the corresponding diagnostic command and transmits the collected diagnostic information to the cable headend through the cablecard 240 in accordance with the given rule.

FIG. 4 illustrates the generic diagnostic protocol. In other words, the diagnostic request protocol is shown as diagnostic_req( ) APDU, and the diagnostic response protocol is shown as diagnostic_cnf( ) APDU. Accordingly, if the cable STB 220 transmits the 3D status information to the cablecard 240 in accordance with the diagnostic response protocol, the cablecard 240 may transmit the 3D status information received from the cable STB 220 to the cable headend located in a remote place or output the 3D status information on a screen of the digital broadcast receiver 210 through a cable menu interface implemented in the digital broadcast receiver 210 or the cable STB 220.

In this case, if the user selects a diagnostic item from a cable menu of the digital broadcast receiver 210 or the cable STB 220 by using the cable menu interface, the cable menu interface may be displayed on the screen by transmitting the item to the digital broadcast receiver 210 in a format of HyperText Markup Language (HTML) files. At this time, the cable menu interface indicates a user talk window that allows the user to recognize diagnostic information.

In this case, in the method for transmitting diagnostic information of the cable broadcast receiver according to the present invention, diagnostic identification (ID) on the 3D status information of the cable broadcast receiver according to the present invention may be defined separately.

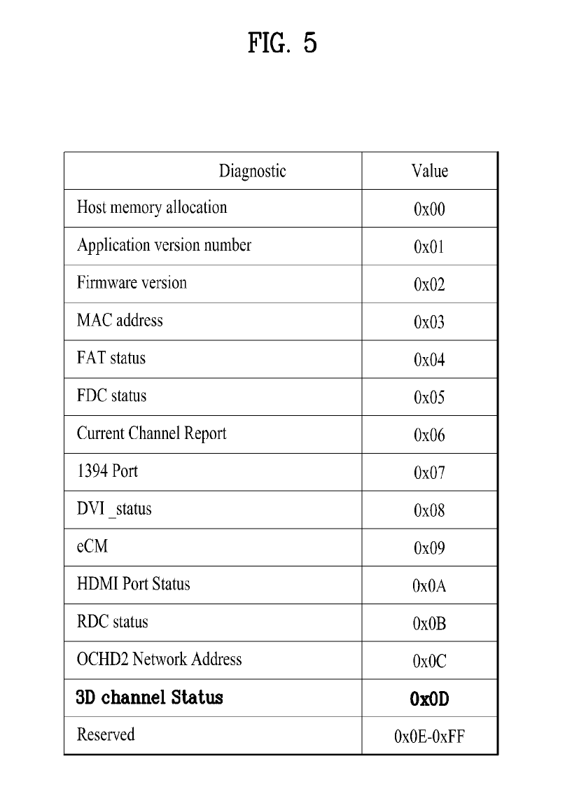

In this respect, FIG. 5 is a diagram illustrating an example of diagnostic ID for 3D status information in a method for transmitting diagnostic information of a cable broadcast receiver according to the present invention.

Referring to FIG. 5, in order to define the 3D status information as one of the diagnostic information in the present invention, ‘0x0D’ has been allocated as diagnostic information ID. Accordingly, the ID means request and response of 3D status information diagnosis in case of diagnostic request and diagnostic response based on the diagnostic protocol.

If the diagnostic request is received from the cablecard 240 by using ‘0x0D’ as diagnostic ID, the cable STB 220 collects the 3D status information on the basis of the diagnostic ID, and transmits the collected 3D status information to the cablecard 240 in accordance with the diagnostic response protocol.

For example, if the diagnostic ID is ‘0x08’, the cablecard 240 requests the cable STB 220 of DVI status information. Also, if the diagnostic ID is ‘0x0A’, the cablecard 240 checks a status of HDMI connected for interfacing between the cable STB 220 and the digital broadcast receiver 210. In addition, the cablecard 240 may define and use a plurality of kinds of diagnostic information (eCM, RDC status, and OCHD 2 Network Address) by giving corresponding diagnostic ID to the diagnostic information.

In this respect, the interface between the cablecard 240 and the cable STB 220 may have a single-stream cablecard interface type and a multi-stream cablecard interface type. The single-stream cablecard interface processes allows the cablecard 240 to process one broadcast stream and allows the cable STB 220 or the digital broadcast receiver 210 to decode the one broadcast stream. The multi-stream cablecard interface processes allows the cablecard 240 to process a plurality of broadcast streams and allows the cable STB 220 or the digital broadcast receiver 210 to decode the plurality of broadcast streams.

The digital broadcast receiver 210 or the cable STB 220 is not currently provided with the standard related to support of the 3D channel. Accordingly, even though the cable headend transmits the 3D channel, the digital broadcast receiver 210 or the cable STB 220 may not identify whether the corresponding channel is the 3D channel. Also, since signaling information such as a format of the 3D video data transmitted through the 3D channel is not defined at all, a problem occurs in that it is difficult to properly play the signaling information regardless of identification of the 3D channel even though the signaling information is received.

Accordingly, the 3D status information is defined as one of diagnostic information in accordance with the present invention to solve the above problems.

For example, according to the present invention, 1) if a given time passes, the cable headend requests each cable broadcasts receiver 200 connected thereto through the cable network to diagnose the 3D status information as to whether the corresponding cable broadcast receiver 200 supports the 3D channel, 2) if each cable broadcast receiver 200 collects the 3D status information and transfers the collected 3D status information to the cable headend by using bidirectional communication, 3) the cable headend or the cable broadcast station acquires/stores the 3D status information of each cable broadcast receiver 200, and 4) if the 3D service is supported through the 3D channel on the basis of the stored 3D status information, the 3D service is provided to the corresponding cable broadcast receivers 200 that support the 3D service, whereby a bandwidth may be reduced, and each cable broadcast receiver 200 may receive a service of high quality and provide the received service to the user as well as reduce a receiving error and enhance efficiency.

In addition, the 3D status information according to the present invention may be used for billing based on the 3D service provided from the cable headend or the cable broadcast station to the corresponding cable broadcast receiver 200. For example, the 3D status information may be defined to include information related to a viewing channel and viewing time for use in billing. And, the cable headend requests the corresponding cable broadcast receiver of 3D channel viewing time for a unit of given time and receives response information based on the request to apply proper billing to each cable broadcast receiver 200, whereby a profit structure at the transmitting side may be improved.

Also, in addition to billing usage, the 3D status information may provide a differentiated service to the corresponding cable broadcast receiver 200 as the transmitting side identifies a main viewing channel, service or contents. For example, if a specific cable broadcast receiver 200 has a high viewing level for a specific content, various kinds of information related to the corresponding content, for example, re-run information, broadcast time of related series, retransmission time, channel information, and related text or image information may previously be provided to the user to result in the user's viewing and additionally obtain win-win effect through billing based on the user's viewing.

Hereinafter, the case where the cablecard 240 processes the single-stream (hereinafter, referred to as “S-mode”) and the case where the cablecard 240 receives multi-streams (hereinafter, referred to as “M-mode”) will be described based on technical spirits of the present invention.

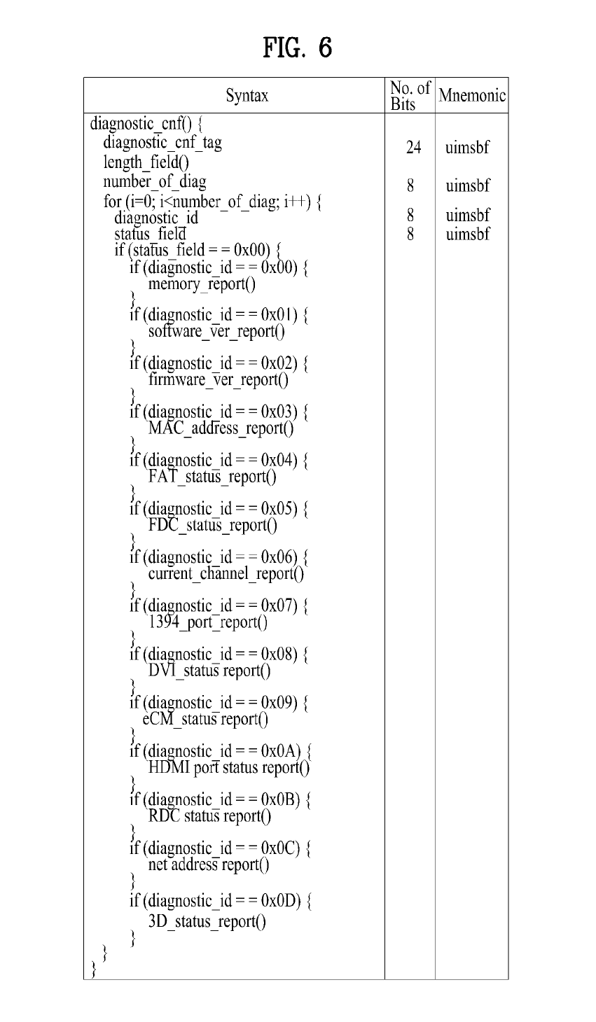

First of all, FIG. 6 is a diagram illustrating an example of signal syntax based on a diagnostic response protocol when a single-stream is received (S-mode) in a method for transmitting diagnostic information according to the present invention.

Referring to the description of FIG. 5, if the cablecard sets a diagnostic ID value to ‘0x0D’ to determine the 3D status information and requests the cable STB 220 of diagnostic request in accordance with the diagnostic protocol, the cable STB 220 collects the 3D status diagnostic information and transmits the collected result to the cable card in response to the diagnostic protocol.

In this case, the cablecard 240 parses the number of diagnostic information (number_of_diag) responded by the cable STB 220 in accordance with the diagnostic protocol. Also, the cablecard 240 performs 3D_status_report( ) object having a diagnostic ID value of ‘0x0D’. As a result, the cablecard 240 acquires the 3D status information of the cable broadcast receiver from the response information and transmits the acquired 3D status information to the cable headend.

According to the present invention, the cablecard 240 may parse a 3D status information signal drafted by the cable STB 220 in accordance with the diagnostic response protocol by using the syntax.

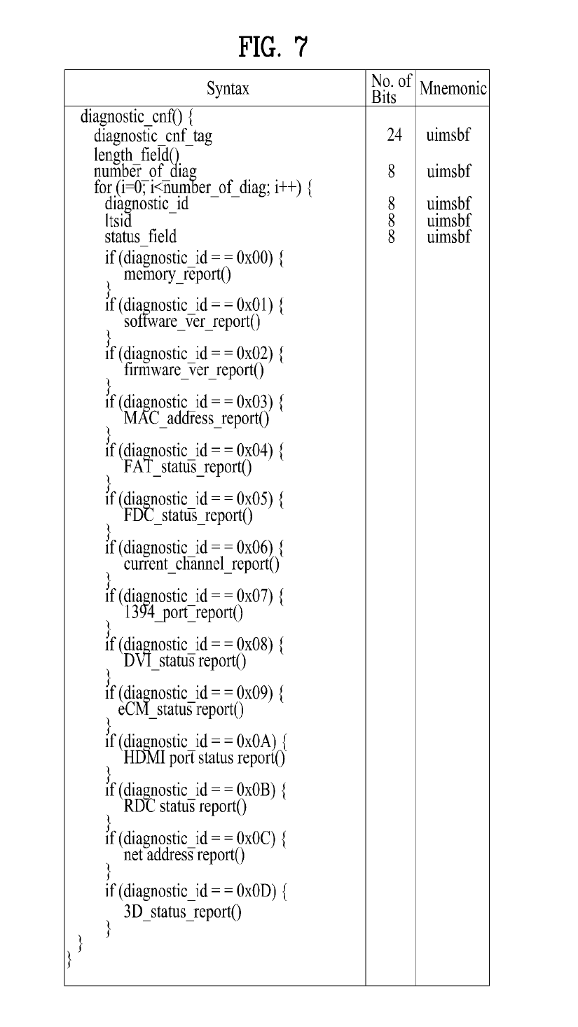

Next, FIG. 7 is a diagram illustrating an example of signal syntax based on a diagnostic response protocol when a cable broadcast receiver according to the present invention receives and multiplexes a plurality of broadcast streams (M-mode).

The syntax of FIG. 7 is different from that of FIG. 6 in that each stream ID is applied to the multiplexed streams. In the example of FIG. 7, the cablecard 240 may receive the 3D status information collected by the cable STB 220, and may acquire 3D status diagnostic information of the cable broadcast receiver by performing 3D_status_report( ) having diagnostic ID of ‘0x0D’.

Hereinafter, the 3D status information according to the present invention will be described in more detail.

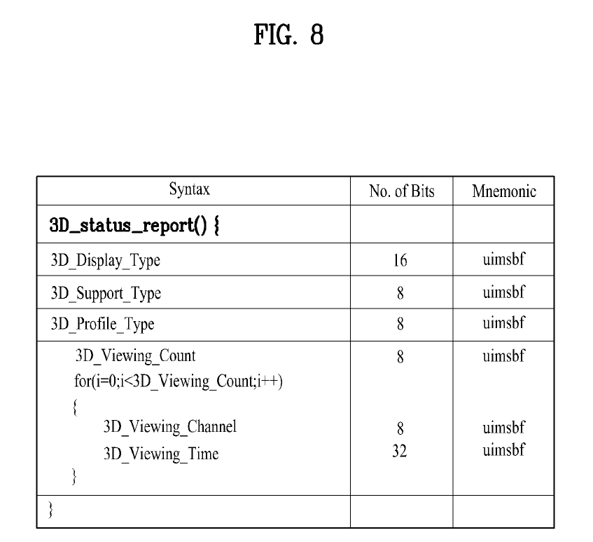

FIG. 8 is a diagram illustrating an example of 3D status information (HOST_{—}3D_status_report) syntax according to the present invention.

Referring to FIG. 8, if diagnostic_req( ) APDU, which includes ID (see FIG. 5, 3D channel status ID) for request of 3D status information diagnosis, is received from the cablecard 240, the 3D status information according to the present invention is the information collected by the cable STB 220 to respond to the request.

First of all, if diagnostic_req( ) APDU is received from the cablecard 240, the cable STB 220 determines diagnostic information requested from the cablecard 240 by parsing the received diagnostic_req( ) APDU. If the diagnostic_req( ) APDU received from the cablecard 240 is determined as the diagnostic request for the 3D status information of the cable broadcast receiver according to the present invention, the cable STB 220 collects the status information, that is, 3D_status_report( ), which will be described later, and transmits the collected status information to the cable card 240 through diagnostic_cnf( ) APDU, wherein the collected status information is included in the diagnostic_cnf( ) APDU. In this case, the cable STB 220 may previously collect the 3D status information of the digital broadcast receiver 210 connected to the interface such as HDMI 1.4 and store the collected 3D status information therein. Then, the cable STB 220 may directly transmit the 3D status information to the cablecard 240 in case of the corresponding request, or may transmit the 3D status information to the cablecard 240 by requesting the corresponding digital broadcast receiver 210 of the 3D status information in real time and receiving the 3D status information whenever the request occurs.

One example of the 3D status information according to the present invention may include at least one of first information indicating a 3D format that can be supported by the digital broadcast receiver, second information indicating a 3D decoding type in respect of 3D channel support in the digital broadcast receiver, third information on 3D related video coding and display (maximum) performance in the digital broadcast receiver, fourth information on a 3D channel which is being viewed by the user, fifth information on a viewing time of the transmitted 3D channel, sixth information indicating a preferred one of a plurality of 3D channels, and seventh information indicating a preferred content from one or more 3D channels.

For example, in respect of the first information, a 3D display type may include at least one of a top-bottom type, a side by side type, a horizontal line interleaving type, a vertical line interleaving type, a checkerboard type, a frame sequential type, a 3D holographic type, and a full resolution multi-view type.

In respect of the second information, the 3D decoding type may include at least one of 2D legacy on a single video decoder, 2D+depth, simulcast on a dual video decoder, 2D+3D in non-real time (NRT), and Multi-view Video Coding (MVC).

In respect of the third information, 3D related video coding and display performance may include at least one of 720p30, 720p60, 1080p30, 1080i60, 1080p60, 480p30, and 480p60.

Hereinafter, one example of the 3D status information (3D_status_report( )) according to the present invention will be described in more detail.

A 3D_Display_Type field indicates 3D type information on an external display device connected with the cable STB 222, that is, the digital broadcast receiver 210. In other words, this field indicates capability of the digital broadcast receiver 210 connected with the cable STB 220. The cable STB 220 and the digital broadcast receiver 210 are connected to each other through a method defined in the HDMI standard as described above. The cable STB 220 may transmit and receive display capability information to and from each other in a signal transmission and reception process between a source, i.e., the cable STB 220 and a sink, i.e., the digital broadcast receiver 210 through the above connection. In this case, each bit of the 3D_Display_Type field indicates whether to support a specific 3D stereo format, and each bit value may be defined as illustrated in Table 1 below.

TABLE 1

| | |
|---|---|
| B15 (MSB) | Top/Bottom |
| B14 | Side by Side |
| B13 | Horizontal Line Interleaving |
| B12 | Vertical Line Interleaving |
| B11 | Checkerboard |
| B10 | Frame Sequential |
| B9 | 3D (Holographic) |
| B8 | Full Resolution Multi-View |
| B7~B0 | reserved if B8 = 0, number of Views if B8 = 1 |

For example, if the 3D_Display_Type field has a value of ‘1100 0000 0000 0000’, it means that the digital broadcast receiver 210 connected to the cable STB 220 support the top-bottom format and the side by side format only. If this field has a value of ‘0’, that is, if all the bits are ‘0’, it may be defined that no 3D format is supported. Accordingly, in this case, it may be regarded that 3D output is not supported.

Also, although the 3D_Display_Type field may indicate a stereo format supported by the cable STB 220 and the digital broadcast receiver 210, if the user forcibly sets a 2D viewing mode through key input, it may be defined that every bit of the 3D_Display_Type field has a value of ‘0’.

A 3D_Support_Type field indicates a 3D decoding type that may be decoded by the digital broadcast receiver 210 that supports a 3D channel. Since a value of this field is mainly related to codec capability, a detailed example of codec capability of this field value may be defined as illustrated in Table 2 below.

TABLE 2

| | codec capability |
|---|---|
| 0x00 | 2D Legacy-single video decoder |
| 0x01 | 2D + Depth |
| 0x02 | Simulcast-dual video decoder |
| 0x03 | 2D + 3D in NRT |
| 0x04 | MVC |
| 0x05~0xFF | reserved |

Whether the corresponding broadcast receiver 210 supports a 3D channel may be identified by using both the 3D_Display_Type field and the 3D_Support_Type field. When information for 3D channel support is transmitted to the cable headend, information included in these two fields may be transmitted.

A 3D_Profile_Type field indicates 3D related video coding and display capability of the digital broadcast receiver 210 or the cable STB 220 in more detail. In other words, the 3D_Profile_Type field indicates maximum capability of the digital broadcast receiver 210 that supports a 3D channel. A value of this field may be defined as illustrated in Table 3 below.

TABLE 3

| | |
|---|---|
| 0x00 | 720p30 |
| 0x01 | 720p60 |
| 0x02 | 1080p30 |
| 0x03 | 1080i60 |
| 0x04 | 1080p60 |
| 0x05 | 480p30 |
| 0x06 | 480p60 |
| 0x07~0xFF | reserved |

Consequently, even though the 3D_Display_Type field and the 3D_Support_Type field are compatible with each other, if a 3D content provided from a specific channel needs capability higher than that of the 3D_Profile_Type field, the corresponding cable broadcast receiver cannot output the corresponding content.

Accordingly, the corresponding cable broadcast receiver may perform effective service control through an interface with the headend.

A 3D_Viewing_Count field indicates a count value for 3D channel information viewed by the corresponding broadcast receiver to later use the viewing time of the transmitted 3D channel as statics such as billing. In this case, although the 3D_Viewing_Count field may be used equally to a 3D_Viewing_Time field which will be described later, it may be used to mean accumulated viewing time such as content unit, day unit, week unit, month unit, quarter unit, and year unit more broadly.

A 3D_Viewing_Channel field indicates information on a 3D virtual channel received and viewed suing the cable broadcast receiver. For example, the 3D_Viewing_Channel field may mean information on a 3D channel which is currently being viewed by the corresponding cable broadcast receiver.

The 3D_Viewing_Time field may transmit the viewing time of the corresponding 3D virtual channel information in a second unit of a given time period. For example, the 3D_Viewing_Time field may count the viewing time of the channel which is currently being viewed, by interacting with the 3D_Viewing_Channel field and define the counted viewing time by using a unit such as second, minute and hour.

A method for diagnosing 3D status information in a cable broadcast system and providing a 3D broadcasting service on the basis of the diagnosed 3D status information in accordance with the present invention will be described based on the aforementioned description.

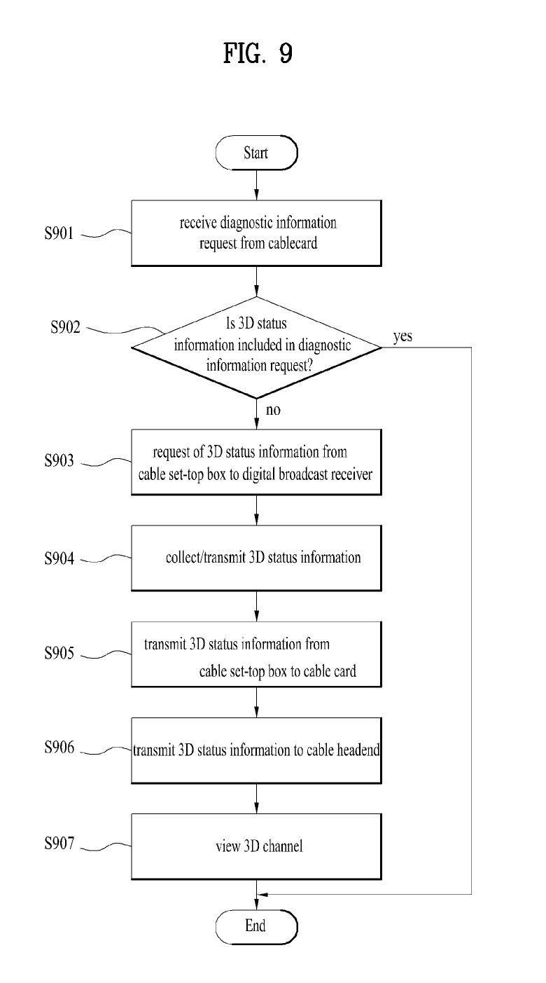

FIG. 9 is a flow chart illustrating a method for diagnosing and transmitting 3D status information and providing a 3D broadcasting service according to the present invention.

An example of a method for diagnosing and transmitting 3D status information and providing a 3D broadcasting service according to the present invention will be described with reference to FIG. 9.

First of all, if diagnosis on 3D status information of the cable broadcast receiver 210 is requested from the outside, that is, the cable headend or the user, the cablecard 240 transmits the request to the cable STB 220 in accordance with a diagnostic protocol which is previously scheduled, and requests the cable STB 220 of corresponding diagnostic information. In this case, the generic diagnostic protocol of FIG. 4 may be used as the diagnostic protocol which is previously scheduled. In this case, referring to FIG. 5, diagnosis ID on the 3D status information is ‘0x0D’. Accordingly, the cablecard 240 transmits the diagnostic ID (0x0D) to the cable STB 220 together with ‘diagnostic_req( ) APDU’, wherein the diagnostic ID is included in the ‘dagnostic_req( ) APDU’.

If the ‘diagnostic_req( ) APDU’ is received from the cablecard 240 (S901), the cable STB 220 parses the diagnostic ID included in the ‘diagnostic_req( ) APDU’ and determines whether the parsed diagnostic ID is that for the 3D status information, that is, ‘0x0D’ (S902).

As a result, if the diagnosis requested from the cablecard 240 is for the 3D status information of the cable broadcast receiver, the cable STB 220 collects the 3D status information. In this case, the cable STB 220 should perform communication with the digital broadcast receiver 210 connected to the HDMI. In other words, the cable STB 220 which was requested the 3D status information of the cable broadcast receiver requests the cable broadcast receiver to collect the 3D status information in response to the request (S903). The digital broadcast receiver collects the 3D status information as shown in FIG. 8 in accordance with the request of the cable STB 220 and again transmits the collected 3D status information to the cable STB 220 (S904).

The cable STB 220 transmits ‘diagnostic_cnf( ) APDU’, which includes the 3D status information, to the cablecard 240 in accordance with a response protocol of the diagnostic protocol which is previously scheduled (S905).

The cablecard 240 parses the ‘diagnostic_cnf( ) APDU’ responding to the 3D status information request from the cable STB 220, and transmits the 3D status information included in the parsed ‘diagnostic_cnf( ) APDU’ to the cable handend or displays the 3D status information through an on screen display (OSD) (S906).

If the 3D status information of the corresponding cable broadcast receiver 200 is received from the cablecard 240 as described above, the cable headend identifies the 3D status of the corresponding cable broadcast receiver 200 on the basis of the received 3D status information. Also, the cable headend may separately store the 3D status information of each cable broadcast receiver 200 and construct a database. For example, the cable headend may store the 3D status information according to the present invention by dividing the 3D status information into the 3D status information on a cable broadcast receiver that can support a 3D channel and the 3D status information on a cable broadcast receiver that cannot support a 3D channel.

As described above, the cable headend provides a proper 3D broadcasting service to the corresponding cable broadcast receiver 200 on the basis of the 3D status information identified for each cable broadcast receiver 200. Accordingly, the corresponding cable broadcast receiver may provide the user with the 3D channel to view the 3D channel (S907).

As described above, the 3D status information of each cable broadcast receiver according to the present invention may be defined as one of the diagnostic information, whereby more exact information on the 3D status may be shared between the transmitting side and the receiving side by using the diagnostic protocol which is previously scheduled. As a result, since the 3D channel is provided to the corresponding cable broadcast receiver only which supports the 3D channel, bandwidth loss may be avoided, and a differentiated service based on information such as preference of each cable broadcast receiver may be provided on the basis of the 3D status information. Also, billing system may be improved using billing related information as described above. Moreover, if the 3D channel that can be processed by the receiving side is provided, system efficiency may be prevented from being deteriorated and error operation may be prevented from occurring.

According to the present invention, the following advantages may be obtained. First of all, as 3D status information is defined as one of diagnostic protocols, each cable broadcast receiver may diagnose the 3D status information. Second, as the 3D status information is shared by a transmitting side, the transmitting side may avoid bandwidth loss, provide a differentiated service to each cable broadcast receiver, and improve a billing system for each cable broadcast receiver. Third, since a receiving side may search for and access its supportable channel based on the 3D status information, system efficiency may be prevented from being deteriorated and error operation of the receiver may previously be prevented from occurring. Finally, an influence on the existing 2D broadcasting service may be minimized using the 3D status information, and the 3D broadcasting service may be provided efficiently.

The method according to the present invention may be implemented in a program instruction type that can be performed through various computer means, and may be recorded in a computer readable recording medium. The computer readable recording medium may include program instructions, data files, and data structures, alone or in combination. The program instructions recorded in the computer readable recording medium are designed specially for the present invention but may be well known to those skilled in the computer software. Examples of the computer readable recording medium include magnetic media such as hard disks, floppy disks, and magnetic tapes, optical media such as CD-ROM and DVD, magneto-optical media such as floppy disks, and a hardware device such as ROM, RAM, and flash memory, which is especially configured to store and perform program instructions. Examples of the program instructions include a machine language code made by a compiler and a high-level language code implemented using an interpreter by a computer. The hardware device may be configured as at least one software module to perform the operation of the present invention, and vice versa.

As described above, the present invention may be applied to a digital broadcast system fully or partially. In particular, the present invention may be applied to a cable broadcast system and a 3D broadcast system fully or partially.

It will be apparent to those skilled in the art that the present invention can be embodied in other specific forms without departing from the spirit and essential characteristics of the invention. Thus, the above embodiments are to be considered in all respects as illustrative and not restrictive. The scope of the invention should be determined by reasonable interpretation of the appended claims and all change which comes within the equivalent scope of the invention are included in the scope of the invention.

1. A cable broadcast receiver, comprising:
a first part configured to receive a request for diagnostic information on 3-dimensional (3D) status for a second part, and transmit the request for diagnostic information on 3D status to the second part; and
the second part configured to collect the diagnostic information on 3D status and transmit the collected diagnostic information on 3D status to the first part,
wherein the first part is further configured to transmit the diagnostic information on 3D status of the second part to an external device, receive a 3D broadcasting service from the external device based on the diagnostic information on 3D status of the second part, process the 3D broadcasting service and transmit the 3D broadcasting service to the second part.

2. The cable broadcast receiver of claim 1, wherein the diagnostic information on 3D status includes first information representing a 3D format type supported by the second part.

3. The cable broadcast receiver of claim 2, wherein the first information indicates any one of a Top-Bottom format, a side-by-side format, a horizontal line interleaving format, a vertical line interleaving format, a checkerboard format, a frame sequential format, a 3D holographic format and a full-resolution multi-view format.

4. The cable broadcast receiver of claim 2, wherein the diagnostic information on 3D status further includes second information representing a 3D decoding type related to supporting a 3D channel of the second part.

5. The cable broadcast receiver of claim 4, wherein the second information indicates any one of 2D legacy type for a single video decoder, a 2D plus depth for the single video decoder, a simulcast for a dual video decoder, a 2D plus 3D for a Non-Real Time (NRT) and MVC.

6. The cable broadcast receiver of claim 4, wherein the diagnostic information on 3D status further includes third information on a video coding method and a capability of displaying related to 3D of the second part.

7. The cable broadcast receiver of claim 6, wherein the third information indicates any one of a 720p30, 720p60, 1080p30, 1080i60, 1080p60, 480p30 and 480p60.

8. The cable broadcast receiver of claim 6, wherein the diagnostic information on 3D status further includes at least one of fourth information on a 3D channel currently being viewed by a user and fifth information on a displaying time of the 3D channel.

9. The cable broadcast receiver of claim 8, wherein the diagnostic information on 3D status further includes at least one of sixth information indicating a Favorite channel of a plurality of 3D channels and seventh information indicating a Favorite content in one or more 3D channels.

10. A cable broadcast receiver, comprising:
a first part configured to receive a request for diagnostic information on 3D status of the first part from a second part, collect the diagnostic information on 3D status, transmit the collected diagnostic information on 3D status to the second part,
wherein the first part is further configured to receive a 3D broadcasting service in accordance with the transmitted diagnostic information on 3D status from the second part and display the 3D broadcasting service.

11. A method of processing a 3-dimensional (3D) broadcasting service in a cable broadcast receiver, the method comprising:
receiving, at a first part, a request for diagnostic information on 3D status of a second part;
transmitting the request for the diagnostic information on 3D status to the second part;
receiving the collected diagnostic information on 3D status from the second part;
transmitting the diagnostic information on 3D status to an external device;
receiving a 3D broadcasting service from the external device based on the diagnostic information on 3D status; and
processing the 3D broadcasting service and transmitting the 3D broadcasting service to the second part.

12. The method of claim 11, wherein the diagnostic information on 3D status includes first information representing a 3D format type supported by the second part.

13. The method of claim 12, wherein the first information indicates any one of a Top-Bottom format, a side-by-side format, a horizontal line interleaving format, a vertical line interleaving format, a checkerboard format, a frame sequential format, a 3D holographic format and a full-resolution multi-view format.

14. The method of claim 12, wherein the diagnostic information on 3D status further includes second information representing a 3D decoding type related to supporting a 3D channel of the second part.

15. The method of claim 14, wherein the second information indicates any one of 2D legacy type for a single video decoder, a 2D plus depth for the single video decoder, a simulcast for a dual video decoder, a 2D plus 3D for a Non-Real Time (NRT) and MVC.

16. The method of claim 14, wherein the diagnostic information on 3D status further includes third information on a video coding method and a capability of displaying related to 3D of the second part.

17. The method of claim 16, wherein the third information indicates any one of a 720p30, 720p60, 1080p30, 1080i60, 1080p60, 480p30 and 480p60.

18. The method of claim 16, wherein the diagnostic information on 3D status further includes at least one of fourth information on a 3D channel currently being viewed by a user and fifth information on a displaying time of the 3D channel.

19. The method of claim 18, wherein the diagnostic information on 3D status further includes at least one of sixth information indicating a Favorite channel of a plurality of 3D channels and seventh information indicating a Favorite content in one or more 3D channels.

20. A method of processing a 3-dimensional (3D) broadcasting service in a cable broadcast receiver, the method comprising:
receiving a request for diagnostic information on 3D status of a first part;
collecting the diagnostic information on 3D status;
transmitting the collected diagnostic information on 3D status to a second part;
receiving a 3D broadcasting service in accordance with the transmitted diagnostic information on 3D status from the second part; and
displaying the 3D broadcasting service.
